(19) United States
(12) Patent Application Publication
(10) Pub. No.: US 2023/0197305 A1
(43) Pub. Date: Jun. 22, 2023

(54) LASER ABLATION SYSTEM AND METHOD

(71) Applicant: Eclipse Automation Inc., Cambridge (CA)

(72) Inventor: Greg Ferguson, Cambridge (CA)

(21) Appl. No.: 18/145,403

(22) Filed: Dec. 22, 2022

Related U.S. Application Data
(60) Provisional application No. 63/292,911, filed on Dec. 22, 2021.

(51) Int. Cl. G21F 9/00; B01D 46/71; B23K 26/16; B23K 26/362

(52) U.S. Cl. CPC G21F 9/005; B01D 46/71; B23K 26/16; B23K 26/362; B01D 2273/28

(57) ABSTRACT

Provided is a laser ablation system and method for decontamination of radioactive particles. The system includes a laser head assembly, comprising a laser for ablating radioactive particles from an underlying material, a shroud surrounding the laser for containing the ablated radioactive particles; and a suction nozzle for receiving an airflow from the shroud and releasing the airflow, wherein the airflow contains the ablated radioactive particles, and the waste management system for removing and containing the ablated radioactive particles, comprising a gas pulse regenerable filtration system for removing radioactive particles from the airflow and depositing them in a containment flask, and a vacuum for moving the airflow through the hose into the containment flask.

### TECHNICAL FIELD

The embodiments disclosed herein relate to radioactive waste disposal, and, in particular to laser ablation systems and methods for decontamination of radioactive particles from underlying radioactive materials.

### Introduction

In many modern facilities and systems involving radioactive materials, such as nuclear power generation facilities or systems employing nuclear ordinance, radioactive particles will be deposited upon underlying materials. These particles preclude standard disposal and recycling of the underlying material, and other uses or processing of the underlying material due to the radioactive hazard posed. Removing these particles from the underlying material and thereby decontaminating these facilities and systems require freeing the radioactive particles from the underlying material in a manner that limits human exposure inside a containment barrier and contains the particles for separate disposal.

Conventional decontamination methods require a human worker to enter past the containment barrier to deploy decontamination tools and remove to radioactive particles. In the process, the human worker will be exposed to internal and external of radiation hazards. In certain environments these radiation levels are such that the human worker will be exposed to their annual allotment of radiation in a short period of time often without being able to complete the decontamination process. Even when exposure is low enough to permit human workers to enter the containment barrier this presents a substantial health risk and personal protective equipment impedes the decontamination process. There are also significant costs associated with mitigating these risks and impedances.

Therefore, it is desirable to have a remotely deployable system to remove and segregate the radioactive particles into a controlled container for disposal, leaving the substrate base material radiologically clean and suitable for conventional disposal or recycling while limiting exposure of human workers to radiation.

Accordingly, a laser ablation system for removing radioactive particles is desired that overcomes some of the disadvantages of existing techniques.

### SUMMARY

Provided is a laser ablation system for decontamination of radioactive particles. The system includes a laser head assembly comprising a laser for ablating radioactive particles from an underlying material, a shroud surrounding the laser for containing the ablated radioactive particles, and a suction nozzle for receiving an airflow from the shroud and releasing the airflow, wherein the airflow contains the ablated radioactive particles. The waste management system for removing and containing the ablated radioactive particles comprises a gas pulse regenerable filtration system for removing radioactive particles from the airflow and depositing them in a containment flask, and a vacuum for moving the airflow through the hose into the containment flask.

The waste management system may further include a filtration system for removing radioactive particles from the airflow.

The laser ablation system may be remotely controlled by at least one control panel. The at least one control panel may be located outside a containment barrier of a radioactive particle site. The gas pulse regenerable filtration system may be controlled by the control panel.

A crawler may move the laser head assembly to an ablation site. The crawler my be deployed by a deployment system for transporting the crawler and laser head assembly to a deployment location.

The laser ablation system may further include a cable management system for spooling and unspooling the hose when the crawler delivers the laser head assembly to the ablation site. The cable management system may be further configured to spool and unspool power and data cables connected to the crawler and the laser head assembly.

The laser ablation system may further include a hose for receiving the airflow from the laser head assembly at a first end and releasing the airflow to a waste management system at a second end.

Provided is a method for decontamination of radioactive particles. The method includes laser ablating radioactive particles from an underlying material, containing the ablated radioactive particles, receiving an airflow and releasing the airflow, wherein the airflow contains the ablated radioactive particles, releasing the airflow to a waste management system, and removing and containing the ablated radioactive particles.

The method may further include removing radioactive particles from the airflow and depositing the radioactive particles in a containment flask.

The method may further include removing radioactive particles from the airflow with a secondary second filtration system.

The method may further include remotely controlling the laser ablation system with at least one control panel. The at least one control panel may be located outside a containment barrier of a radioactive particle site. The gas pulse regenerable filtration system may be controlled by the control panel.

The method may further include delivering a laser head assembly to an ablation site with a crawler. The crawler may be deployed by a deployment system for transporting the crawler and laser head assembly to a deployment location.

The method may further include spooling and unspooling a hose when the crawler delivers the laser head assembly to the ablation site.

A cable management system may be configured to spool and unspool power and data cables connected to the crawler and the laser head assembly.

### BRIEF DESCRIPTION OF THE DRAWINGS

The drawings included herewith are for illustrating various examples of articles, methods, and apparatuses of the present specification.

FIG. 1 is a diagram of a radioactive particle site, in accordance with an embodiment;

FIG. 2 is a block diagram of a radioactive particle site including a laser ablation system, in accordance with an embodiment;

FIG. 3A is a perspective view of a schematic diagram of a laser head assembly, in accordance with an embodiment;

FIG. 3B is a cross sectional schematic diagram of the laser head assembly, through section A-A of FIG. 3A;

FIG. 3C is a cut away side view 3D schematic diagram of a laser head assembly, in accordance with an embodiment;

FIG. 4 is a schematic diagram of waste management system of FIG. 1;

FIG. 5 is a 3D schematic diagram of crawler, in accordance with an embodiment;

FIG. 6 is a 3D schematic diagram of crawler in a pipe, in accordance with an embodiment;

FIG. 7 is a 3D schematic diagram of a deployment system, in accordance with an embodiment;

FIG. 8 is a 3D cut away schematic diagram of a cable management system, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

The systems and methods described herein provide a laser ablation system for removing radioactive particles from an underlying material. Laser ablation refers to a process in which a laser heats a surface of a material aerosolizing the top layer of the surface thereby ablating it from the underlying material. The laser ablation system described herein ablates radioactive particles deposited on a surface of an underlying material, thereby aerosolizing the radioactive particles from the underlying surface. A vacuum moves the airflow containing the radioactive particles through a hose to waste management system where the radioactive particles are filtered out of the airflow and into a containment flask.

The extent to which removing radioactive particles from the underlying surface would cause the underlying material to be classified as safe for disposal/recycling may vary based on factors such as radioactive particle surface accumulation and underlying material thickness and composition. As such, the magnitude of the radioactive particles ablated may be guided by the ablation site conditions. This magnitude may also incorporate a desired tolerance to ensure the safe status of the underlying material.

Discussed herein are various components of a laser ablation system. It is to be understood that these components may vary for different radioactive particle sites.

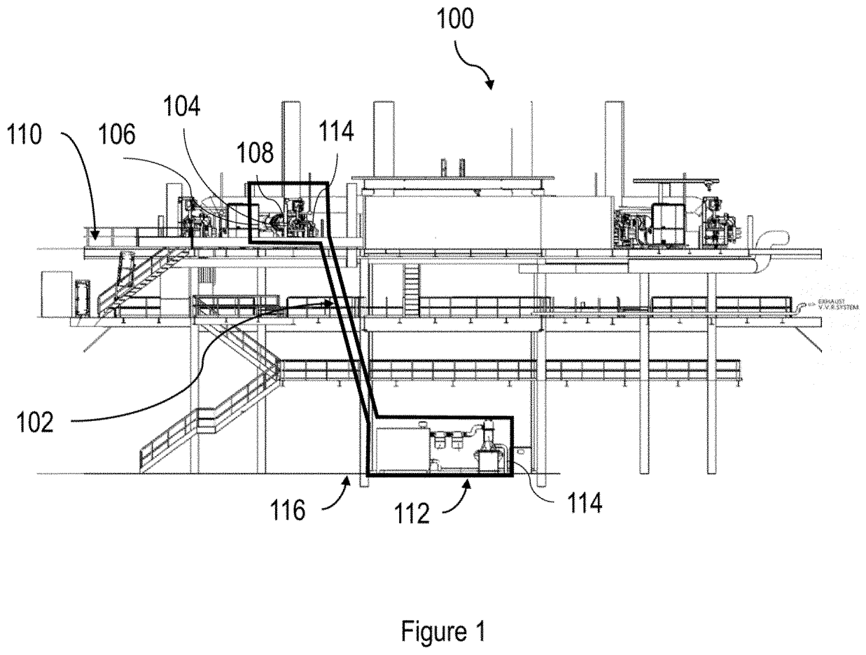

Reference will now be made to FIG. 1, shown therein is a radioactive particle site 100, for example, a nuclear facility, with a laser ablation system 102 deployed within, according to an embodiment. As shown therein, a laser head assembly 104 is deployed to an deployment location 106 via a deployment system 108 on an upper level 110 of the radioactive particle site 100. The laser head assembly 104 is connected to a waste management system 112 via a hose 114. The waste management system 112 is generally deployed on a lower level 116 of the radioactive particle site 100 due to the weight of the waste management system 112. In other embodiments, the waste management system 112 may be located in another area of the radioactive particle site 100.

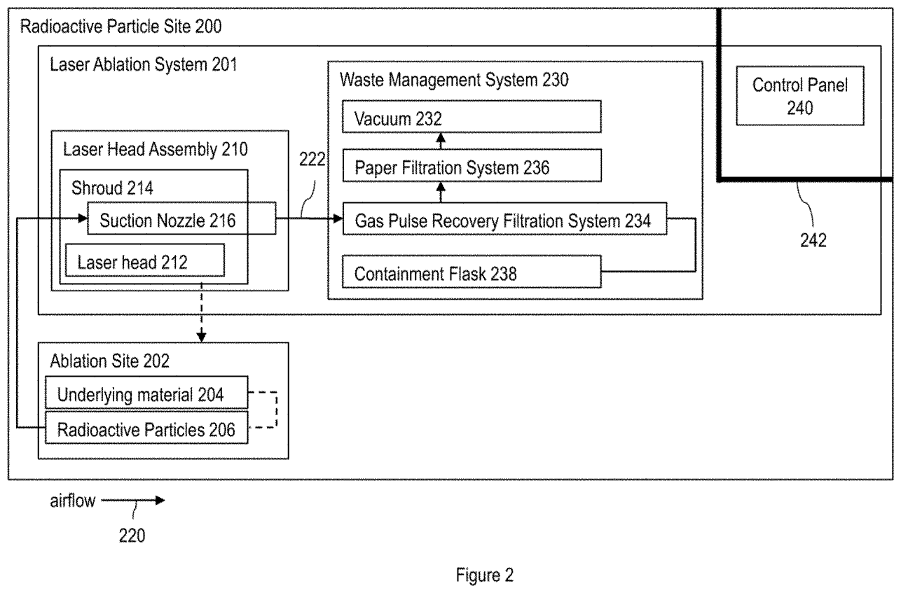

Referring now to FIG. 2, shown therein is a block diagram illustrating a radioactive particle site 200 including a laser ablation system 201, in accordance with an embodiment. The laser ablation system 201 may be the laser ablation system 102 shown in FIG. 1. The radioactive particle site 200 includes one or more ablation sites 202 wherein an underlying material 204 is contaminated with radioactive particles 206. These radioactive particles 206 are hazardous to humans and often must be removed from the underlying material 204 for the components that comprise the underlying material 204 to continue to operate, be reused, recycled or disposed of. To remove the radioactive particles 206 from the underlying material 204 a laser head assembly 210 of the laser ablation system 201 is delivered to the ablation site 202.

The laser head assembly 210 includes a laser head 212 which emits a laser beam onto the surface of the ablation site 202 thereby ablating radioactive particles 206 off the surface of the underlying material 204. The laser head 212 includes a laser having with a minimum output of 200 Watts. The laser head 212 may be powered by 3-phase 480 Voltage Alternating Current. The laser head 212 may be air or water cooled. The laser head 212 may be housed in a dust resistant housing. The laser head 212 may be powered by a spooled cable that extends for 16 meters or more. The laser head 212 may further be able to adjust the geometry of the laser beam emitted.

The laser head assembly 210 further includes a shroud 214 which surrounds the laser head 212. The shroud 214 contains the ablated radioactive particles 206, which are aerosolized by laser ablation, from spreading into the surrounding environment.

The laser head assembly 210 also includes a suction nozzle 216. A first end of the suction nozzle 216 pass through the shroud 214 such that the first end of the suction nozzle 216 is internal to the shroud and a second end of the suction nozzle 216 is external to the shroud 214. The suction nozzle 216, therefore, acts as a conduit for an airflow 220 from the ablation site 202 to pass through the shroud 214, the airflow 220 initially including aerosolized radioactive particles 206. The first end of the suction nozzle 216 receives the airflow 220 within the shroud 214 and conveys the airflow 220 to a second end of the suction nozzle 216 which is connected to a first end of a hose 222.

The first end of the hose 222 receives the airflow 220 from the second end of the suction nozzle 216. The first end of the hose 222 may be connected to the suction nozzle 216 in a removable manner to facilitate deployment of the laser ablation system 201. The first end of the hose 222 may also be hard mounted to the suction nozzle 216 to reduce the cost and/or improve the reliability of establishing a desired seal.

A second end of the hose 222, is affixed to a waste management system 230. The second end of hose 222, like the first end of the hose 222, may be removable or hard mounted for similar reasoning.

The waste management system 230 includes a vacuum 232 which provides suction to draw air and generate the airflow 220 from the shroud 214, through the suction nozzle 216 and hose 222 into the waste management system 230. The aerosolized radioactive particles travel to the waste management system 230 in the airflow 220. The vacuum 232 may be configured to operate continuously or at intervals (pulsed) during laser ablation.

The waste management system 220 further includes a first filtration system. The first filtration system is a gas pulse regenerable filtration system 234 for removing radioactive particles 206 from the airflow 220. The airflow exits the hose 222 into the waste management system 230 and is received by the gas pulse regenerable filtration system 234. The gas pulse regenerable filtration system 234 extracts the aerosolized radioactive particles 206 from the airflow 220.

The gas pulse regenerable filtration system deposits the radioactive particles 206 extracted by the gas pulse regenerable filtration system 234 into a containment flask 238 via a gas pulse. The containment flask 238 contains the radioactive particles 206 for removal from the radioactive particle site 200 and further disposal. The containment flask 238 is removable and interchangeable with another containment flask 238 for further operation of the waste management system 230.

The waste management system further includes a second filtration system 236 for removing radioactive particles 206 from the airflow 220. As the gas pulse regenerable filtration system 234 extracts the radioactive particles 206, the second filtration system 236 may only collect low levels of radioactive particles 206 that remain in the airflow 220 after passing through the gas pulse regenerable filtration system 234. This low level of radioactive material means that the filters may be disposed of in a less frequent manner than should the full load of radioactive particles be therein captured. The second filtration system 236, in addition to other systems such as the gas pulse regenerable filtration system, may protect the vacuum 232 from radioactive exposure as well as standard particles (e.g., dust) present in the airflow. The second filter system 236 may include one or more HEPA, and ultra-low paper filters.

The laser ablation system 201 may be controlled by one or more laser ablation control panels 240. The radioactive particle 200 site may include a containment barrier 242 for shielding against radiation. Typically, the laser ablation control panel 240 is located outside of the containment barrier 242 such that an operator will be shielded from radiation while controlling the laser ablation system 201. The laser ablation control panel 240 may be a dedicated control panel, integrated into an existing control panel for the site and/or integrated into a control panel for a component of the laser ablation system 201 such as a control panel for the gas pulse regenerable filtration system 234.

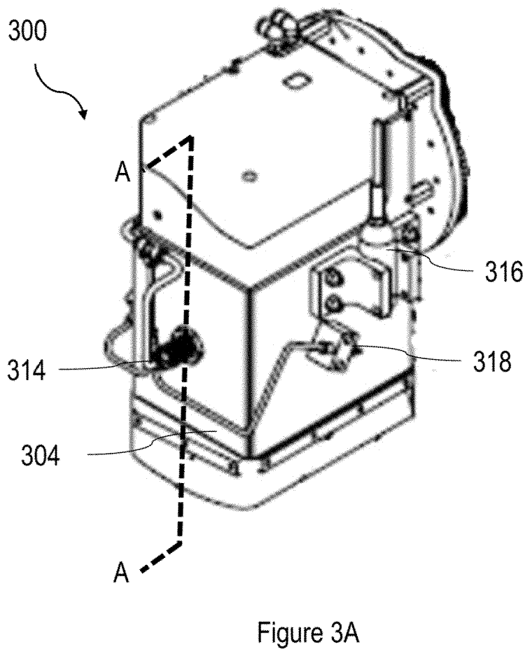

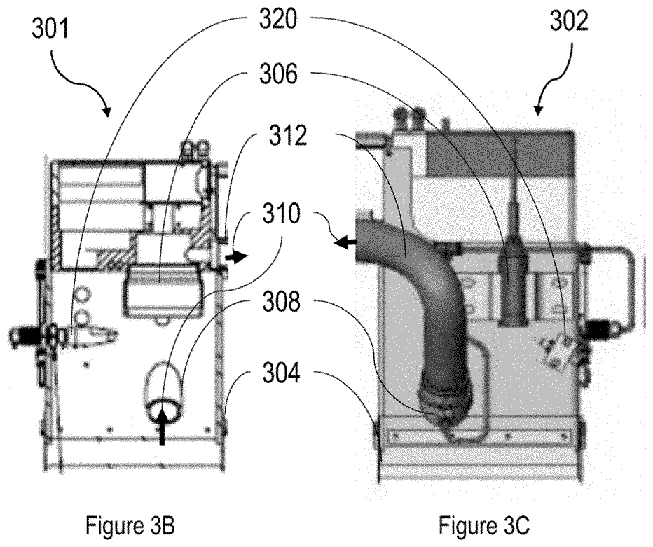

Referring now to FIG. 3A, shown therein is a perspective view schematic diagram of the laser head assembly 210 of FIG. 2, according to an embodiment. The laser head assembly 300 includes a shroud 304 for substantially containing the ablated radioactive particles 206 of FIG. 2.

Referring now to FIGS. 3B and 3C, shown therein are a cross sectional view 301 through section A-A of the laser head assembly 300 of FIG. 3A and a cutaway side view 302 of a laser head assembly, according to an embodiment. Shown therein, is a laser head 306 mounted inside the shroud 304. The laser head 306 emits a laser for ablating the radioactive particles 206 of FIG. 2. Once ablated the shroud 304 substantially contains the aerosolized radioactive particles 206 of FIG. 2. The radioactive particles 206 of FIG. 2, now aerosolized, are drawn into a suction nozzle 308 via an airflow 310. The suction nozzle 308 penetrates the shroud 304 and serves as a conduit for the airflow 310 to exit the shroud 304. The second end of the suction nozzle 308 external to the to the shroud 304 is connected to a first end of a hose 312 which receives the airflow 310 from the suction nozzle 308. The laser head assembly may further include a positive blower 320 that penetrates the shroud 304 and provides air into the shroud 304 from an air source outside the shroud 304.

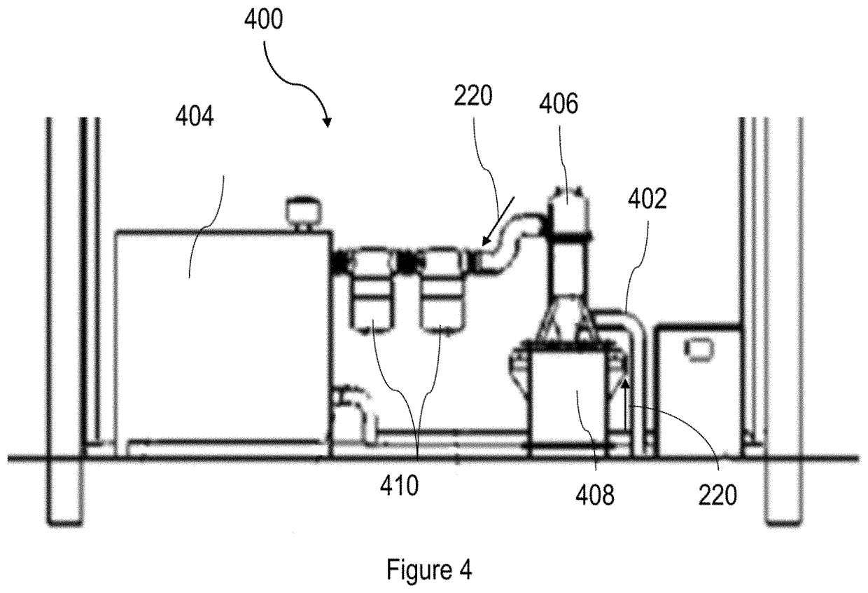

Referring now to FIG. 4, shown therein is a schematic diagram of a waste management system 400, according to an embodiment. The waste management system 400 may be the waste management system 230 of FIG. 2. The waste management system 400 receives the radioactive particles 206 of FIG. 2 via an airflow 220 of FIG. 2 through a hose 402. Suction provided by a vacuum 404 moves the airflow 220 through the waste management system 400. The airflow 220 exits the hose 402 and is received by the gas pulse regenerable filtration system 406. The gas pulse regenerable filtration system substantially filters the radioactive particles 206 of FIG. 2 out of the airflow 220 and uses a gas pulse to deposit the radioactive particles 206 into a containment flask 408 for disposal.

The airflow 220 is further moved from the outlet of the gas pulse regenerable filtration system 406 to a second filtration system 410 which further filters remaining radioactive particles 206 and other foreign particles out of the airflow 220. The primary filtering provided by the gas pulse regenerable filtration system 406 substantially reduces the quantity of particles that are trapped by the second filtration system 410 and therefore reduces the waste generated and maintenance required by the second filtration system 410.

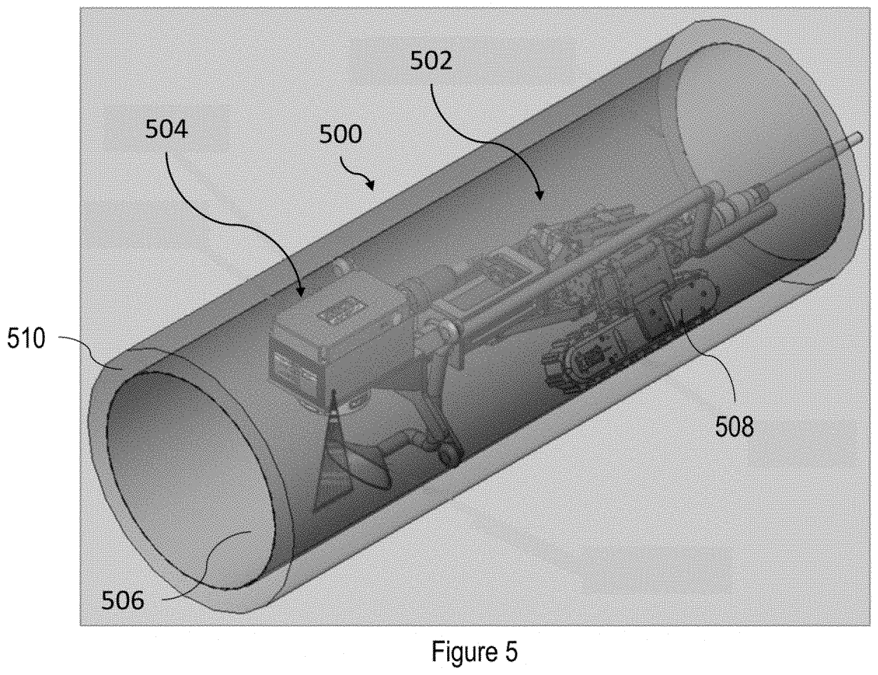

Referring back to FIG. 2, in embodiments where the radioactive particles 206 are deposited on underlying material 204, for example the interior walls of pipes, a crawler 502 of FIG. 5 may be used to deliver the laser head assembly 210 to the ablation site 202 within a pipe.

Referring now to FIG. 5, shown therein is a 3D schematic diagram 500 of a crawler 502 with a laser head assembly 504 mounted to it, delivered to an ablation site 506 within a pipe 510. The pipe 510 may have nominal diameters of 18 inches or 22 inches. The crawler 502 delivers the laser head assembly 504 to the ablation site 506. Delivering the laser head assembly 504 via the crawler 502 provides access to ablation sites 506 not easily accessible by a human worker. The crawler 502 may also mitigate human exposure to radioactivity by delivering the laser head assembly 504 to the ablation site instead of requiring a human worker to do so. The crawler 502 may further provide stability for the laser head assembly 504 during ablation while at the ablation site 506.

The crawler 502 travels through the pipe 510 via one or more tracks 508 which contact the inner wall of the pipe 510. Once the crawler 502 arrives at the ablation site 506 the crawler 502 centers the laser head assembly 504 with respect to the pipe 510. The crawler 502 may proceed through the pipe 510 while the laser head assembly 504 is rotated/oriented such that the laser passes over the ablation site 506 (i.e., the inner surface of the pipe 510) in a helical path. In a preferred embodiment, the crawler 502 progresses through the pipe 510 such that the ablation site 506 receives 3 passes of the laser.

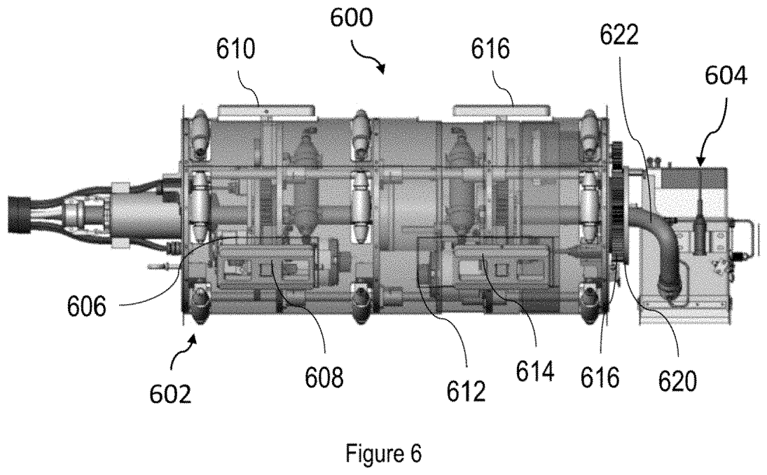

Referring now to FIG. 6, shown therein is 3D schematic diagram 600 of a crawler 602 with the laser head assembly 604 of FIG. 3B mounted to it, in accordance with an embodiment. The crawler 602 includes tracks 606, 608, 610, 612, 614 and 616 for delivering the crawler 602 to the ablation site 506 of FIG. 5.

The crawler 602 further includes spur gears 618 for rotating the laser head assembly as it progresses through the ablation site 506 of FIG. 5. The crawler 602 further includes a crawler slip ring 620 to maintain electric connectivity of the power cables 622 of the laser head assembly 604 without twisting the power cables 622.

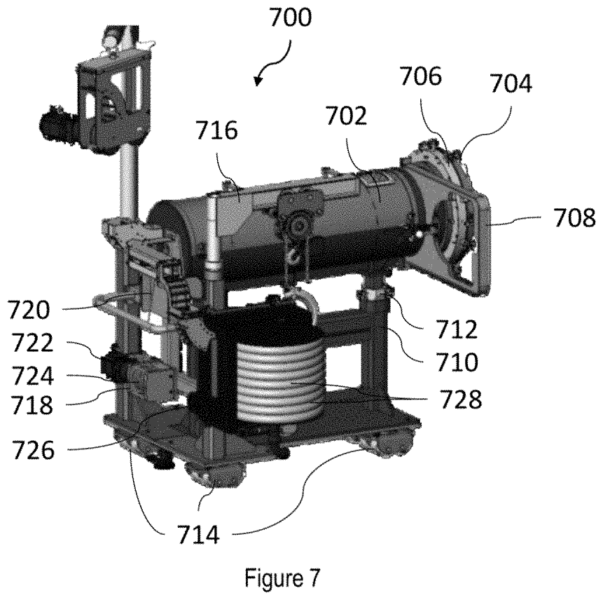

Referring now to FIG. 7 shown therein is a 3D schematic diagram of a deployment system 700 for deploying the crawler 602 and affixed laser head assembly 604 of FIG. 6, according to an embodiment. The deployment system 700 transports the crawler and laser head assembly inside a deployment tube 702 to a pipe access port 704. The deployment tube 702 includes an alignment clamp 706 which couples with the pipe access port 704 to create a seal. In a preferred embodiment, the pipe access port 704 has an 18 inch or 22 inch diameter.

The deployment tube 702 is includes a foreign materials exclusion (FME) gate 708 for preventing any foreign materials from traveling in or out of the deployment tube 702 during ablation. The FME gate may be opened when the once the seal is created and may be opened and closed to allow the crawler and laser head assembly to leave and/or return while maintaining radioactive containment within the deployment tube 702. The crawler 602 and laser head assembly 604 of FIG. 6 can travel from the deployment tube 702 to the ablation site through the pipe access port 704.

The deployment system 700 further includes a frame 710, which supports the other components of the deployment system 700. The frame 710 includes a height adjustment 712 which allows deployment to tube to raise or lower aligning the alignment clamp 706 with the pipe access port 702. This alignment promotes a proper seal of the alignment clamp 706 with the pipe access port 702. The frame 710 is mounted on rollers 714 to facilitate the transport of the deployment system 700 to the pipe access port 702.

The deployment system further includes a jib crane 716 which may be used to replace the hose, should the levels of radioactive contamination approach an unacceptable level. The jib crane 716 may have a lift capacity that exceeds the weight of the hose. The hose may have a weight up to 200 lbs, accordingly the jib crane 716 preferably has a lift capacity of at least 1 ton.

The deployment system 700 further includes a cable winch system 718. The cable 720 of the cable winch system is 718 is attached to the crawler 602 of FIG. 6 at one end and is maintained taught by a winch servo motor 722 driven winch 724 as the crawler 602 of FIG. 6 is deployed from or return towards the deployment tube 702. If the crawler 602 of FIG. 6 is unable to return to the deployment tube 702 under its own power, the cable winch system 718 pulls the crawler 602 of FIG. 6 back to the deployment tube 702. The winch servo motor 722 may be capable of exerting 8.5 Nm of torque which can comfortably pull the crawler out back to the deployment tube 702.

The deployment system 700 further includes a cable management system 726 for managing the cables 728 which power and service the crawler 602 and laser head assembly 604 of FIG. 6. The cables 728 exit the end of the deployment tube 702 farthest from the pipe access port 704 and enter the cable management system 726.

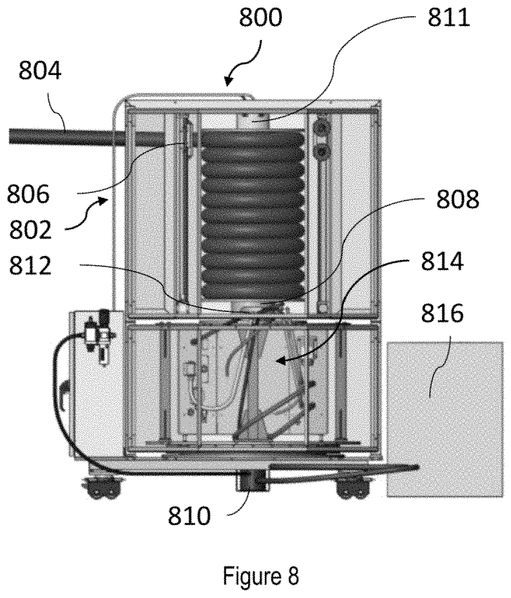

Referring now to FIG. 8 shown therein is a 3D cross sectional schematic diagram 800 of a cable management system 802, according to an embodiment. The cable management system may be the cable management system 726 shown in FIG. 7. The cable management system 802 manages the cables 804 that power and service other mobile components of the laser ablation system 201 of FIG. 2. The power cables 804 enter the cable management system 802 through a spooler 806 and wind about a drum 808.

The cable management system 802 further includes a first drum servo motor 810 and a second drum servo motor 811 for synchronously rotating the drum 808. As the drum 808 rotates, the cables 804 are spooled or unspooled depending on whether the laser head assembly 210 of FIG. 2 is being returned or deployed, respectively. The cable management system 802 spools and unspools the cables 804 while ensuring that the cables 804 do not twist beyond the acceptable fiber optic strain limit of the cables 804. The first drum servo motor 810 and second drum servo motor 811 may each be able to produce at least 1.1 Nm of torque.

The cable management system 802 includes a slip ring 812 which allows the drum 808 to rotate while the cables 804 maintain connectivity with their respective static continuations exiting the slip ring 812. The slip ring 812 may be rated at a current rating of up to 50 amps. Cables 804 which are not compatible with the couplings of the slip ring 812 and may only experience a torsional strain below a prescribed limit, such as fiber optic cables 804, are managed such that the torsional strain that the cables 804 experience remain within these limits.

The power cables 804 pass through an electrical cabinet 814 at the base of the cable management system 802 which provides organized access to the cables for maintenance. The power cables 804 exit the electrical cabinet 814 and connect to an electrical panel 816. The electrical panel 816 connects the power cables 804 to an external voltage source.

While the above description provides examples of one or more apparatus, methods, or systems, it will be appreciated that other apparatus, methods, or systems may be within the scope of the claims as interpreted by one of skill in the art.

1. A laser ablation system for decontamination of radioactive particles, the system comprising:
a laser head assembly, comprising:
a laser for ablating radioactive particles from an underlying material;
a shroud surrounding the laser for containing the ablated radioactive particles; and
a suction nozzle for receiving an airflow from the shroud and releasing the airflow, wherein the airflow contains the ablated radioactive particles; and
the waste management system for removing and containing the ablated radioactive particles, comprising:
a gas pulse regenerable filtration system for removing radioactive particles from the airflow and depositing them in a containment flask; and
a vacuum for moving the airflow through the hose into the containment flask.

2. The laser ablation system of claim 1, wherein the waste management system further comprises a second filtration system for removing particles from the airflow.

3. The laser ablation system of claim 1, wherein the laser ablation system is remotely controlled by at least one control panel.

4. The laser ablation system of claim 3, wherein the at least one control panel is located outside a containment barrier of a radioactive particle site.

5. The laser ablation system of claim 3, wherein the gas pulse regenerable filtration system is controlled by the control panel.

6. The laser ablation system of claim 1, wherein a crawler moves the laser head assembly to an ablation site.

7. The laser ablation system of claim 6, wherein the crawler is deployed by a deployment system for transporting the crawler and laser head assembly to a deployment location.

8. The laser ablation system of claim 6, further comprising a cable management system for spooling and unspooling the hose when the crawler delivers the laser head assembly to the ablation site.

9. The laser ablation system of claim 8, wherein the cable management system is further configured to spool and unspool power and data cables connected to the crawler and the laser head assembly.

10. The laser ablation system of claim 1 further comprising a hose for receiving the airflow from the laser head assembly at a first end and releasing the airflow to a waste management system at a second end.

11. A method for decontamination of radioactive particles, the method comprising:
laser ablating radioactive particles from an underlying material;
generating an airflow to move the ablated radioactive particles; and
filtering the ablated radioactive particles from the airflow.

12. The method of claim 11 further comprising depositing the ablated radioactive particles in a containment flask.

13. The method of claim 11 wherein filtering the ablated radioactive particles from the airflow comprises passing the airflow through a gas pulse regenerable filtration system.

14. The method of claim 11 further comprising remotely controlling the laser ablation with at least one control panel.

15. The method of claim 14, wherein the at least one control panel is located outside a containment barrier of a radioactive particle site.

16. The method of claim 11, wherein the filtering the ablated radioactive particles from the airflow comprises passing the airflow through a second filtration system.

17. The method of claim 11 further comprising delivering a laser head assembly to an ablation site with a crawler.

18. The method of claim 17, wherein the crawler is deployed by a deployment system for transporting the crawler and laser head assembly to a deployment location.

19. The method of claim 17 further comprising spooling and unspooling a hose when the crawler delivers the laser head assembly to the ablation site.

20. The method of clam 19, wherein a cable management system is further configured to spool and unspool power and data cables connected to the crawler and the laser head assembly.
